(19) United States
(12) Patent Application Publication
(10) Pub. No.: US 2023/0273041 A1
(43) Pub. Date: Aug. 31, 2023

(54) SYSTEM AND METHOD FOR NAVIGATION SHOWING DRIVING RANGE-AREA UNTIL DARK

(71) Applicant: Toyota Motor Engineering & Manufacturing North America, Inc., Plano, TX (US)

(72) Inventor: Geoffrey D. Gaither, Ann Arbor, MI (US)

(73) Assignee: Toyota Motor Engineering & Manufacturing North America, Inc., Plano, TX (US)

(21) Appl. No.: 17/680,724

(22) Filed: Feb. 25, 2022

(51) Int. Cl. G01C 21/36; G01C 21/34

(52) U.S. Cl. CPC G01C 21/367; G01C 21/3691; G01C 21/3476

(57) ABSTRACT

A device is provided for use with an external server and a GPS network configured to provide geodetic location data. The external server being configured to provide current time data and sunset time data. The device includes: a display device configured to display a map and a modified map; a memory; and a processor configured to execute instructions stored on the memory to cause the device to: receive the geodetic location data and obtain the geodetic location; receive the current time data and obtain the current time; receive the sunset time data and obtain the sunset time; determine a driving range-area based on the sunset time, the current time, and the geodetic location; and instruct the display device to display the modified map, wherein the modified map includes a modified driving-range area based on the geodetic location, the current time and the sunset time.

### BACKGROUND

Embodiments of the disclosure relate to navigation systems.

### SUMMARY

An aspect of the present disclosure is drawn to a device for use with an external server and a global positioning system (GPS) network configured to provide geodetic location data based on a geodetic location of the device. The external server is configured to provide current time data and sunset time data, wherein the current time data includes a current time value and the sunset time data includes a sunset time value based on the geodetic location. The device includes: a display device configured to display a map and a modified map; a memory; and a processor. The processor is configured to execute instructions stored on the memory to cause the device to perform processes. The processes include receiving the geodetic location data and obtaining the geodetic location. The processes additionally include receiving the current time data and obtaining the current time. The processes additionally include receiving the sunset time data and obtaining the sunset time. The processes additionally include determining a driving range-area based on the sunset time, the current time, and the geodetic location. The processes additionally include instructing the display device to display the modified map. The modified map includes a modified driving-range area based on the geodetic location, the current time and the sunset time.

In some embodiments of this aspect drawn to a device, the modified map further includes a driving-range area based on the geodetic location and the current time, wherein the driving-range area is smaller than the modified driving-range area.

In some embodiments of this aspect drawn to a device, the processor is additionally configured to execute instructions stored on the memory to cause the device to perform additional processes. The additional processes include establishing a back-off time value, wherein the modified map includes a modified driving-range area based on the geodetic location, the current time, the sunset time and the back-off time value. In some of these embodiments, the device is for further use by a user, and the device further includes a user interface circuit configured to enable the user to change the back-off time value. In some of these embodiments, the processor is additionally configured to execute instructions stored on the memory to cause the device to perform additional processes. The additional processes include instructing the user interface circuit to enable the user to change the back-off time value in one-hour increments. In some other embodiments, the user interface circuit is additionally configured to enable the user to search for points-of-interest within the modified map.

In some embodiments of this aspect drawn to a device, the back-off time value is based on a visibility parameter selected from the group of visibility parameters consisting of weather, topography, elevation, and combinations thereof.

Another aspect of the present disclosure is drawn to a method of using a device with an external server and a GPS network configured to provide geodetic location data based on a geodetic location of the device. The external server is configured to provide current time data and sunset time data, wherein the current time data includes a current time value and the sunset time data includes a sunset time value based on the geodetic location. The method includes: receiving, via a processor configured to execute instructions stored on a memory, the geodetic location data and obtaining the geodetic location. The method additionally includes receiving, via the processor, the current time data and obtaining the current time. The method additionally includes receiving, via the processor, the sunset time data and obtaining the sunset time. The method additionally includes determining, via the processor, a driving range-area based on the sunset time, the current time, and the geodetic location. The method additionally includes instructing, via the processor, a display device to display the modified map. The modified map includes a modified driving-range area based on the geodetic location, the current time and the sunset time.

In some embodiments of this aspect drawn to a method of using a device, the modified map further includes a driving-range area based on the geodetic location and the current time, wherein the driving-range area is smaller than the modified driving-range area.

In some embodiments of this aspect drawn to a method of using a device, the method further includes additional processes. The additional processes include establishing, via the processor, a back-off time value, wherein the modified map includes a modified driving-range area based on the geodetic location, the current time, the sunset time and the back-off time value. In some of these embodiments, the method is for further use by a user, and the method further includes enabling, via a user interface circuit, the user to change the back-off time value. In some of these embodiments, the method further includes instructing, via the processor, the user interface circuit to enable the user to change the back-off time value in one-hour increments. In some embodiments, the method further includes enabling, via the user interface circuit, the user to search for points-of-interest within the modified map.

In some embodiments of this aspect drawn to a method of using a device, the back-off time value is based on a visibility parameter selected from the group of visibility parameters consisting of weather, topography, elevation, and combinations thereof.

Another aspect of the present disclosure is drawn to a non-transitory, computer-readable media having computer-readable instructions stored thereon. The computer-readable instructions are capable of being read by a device with an external server and a GPS network configured to provide geodetic location data based on a geodetic location of the device. The external server is configured to provide current time data and sunset time data, wherein the current time data includes a current time value and the sunset time data includes a sunset time value based on the geodetic location. The computer-readable instructions are capable of instructing the network controller device to perform a method. The method includes receiving, via a processor configured to execute instructions stored on a memory, the geodetic location data and obtaining the geodetic location. The method additionally includes receiving, via the processor, the current time data and obtaining the current time. The method additionally includes receiving, via the processor, the sunset time data and obtaining the sunset time. The method additionally includes determining, via the processor, a driving range-area based on the sunset time, the current time, and the geodetic location. The method additionally includes instructing, via the processor, a display device to display the modified map. The modified map includes a modified driving-range area based on the geodetic location, the current time and the sunset time.

In some embodiments of this aspect drawn to a non-transitory, computer-readable media, the computer-readable instructions are capable of instructing the network controller device to perform the method in a certain manner. In particular, the modified map may further include a driving-range area based on the geodetic location and the current time, and wherein the driving-range area is smaller than the modified driving-range area.

In some embodiments of this aspect drawn to a non-transitory, computer-readable media, the computer-readable instructions are capable of instructing the network controller device to perform the method include further processes. The method further includes establishing, via the processor, a back-off time value. The modified map includes a modified driving-range area based on the geodetic location, the current time, the sunset time and the back-off time value. In some of these embodiments, the non-transitory, computer-readable media is for further use by a user, wherein the computer-readable instructions are capable of instructing the network controller device to perform the method including further processes. The further processes include enabling, via a user interface circuit, the user to change the back-off time value. In some of these embodiments, the computer-readable instructions are capable of instructing the network controller device to perform the method including still further processes. The further processes include instructing, via the processor, the user interface circuit to enable the user to change the back-off time value in one-hour increments.

In some embodiments of this aspect drawn to a non-transitory, computer-readable media, the computer-readable instructions are capable of instructing the network controller device to perform the method including further processes. The further processes include enabling, via the user interface circuit, the user to search for points-of-interest within the modified map.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1A illustrates an example navigation map;

FIG. 1B illustrates the navigation map of FIG. 1A with a driving range-area;

FIG. 1C illustrates the navigation map of FIG. 1B with a modified driving range-area based on a back-off time value and points of interest in accordance with aspects of the present disclosure;

FIG. 1D illustrates the navigation map of FIG. 1B with a modified driving range-area based on a back-off time value without points of interest in accordance with aspects of the present disclosure;

FIG. 2 illustrates an algorithm to be executed by a processor in accordance with aspects of the present disclosure;

FIG. 3A illustrates a first example embodiment of a system to use the algorithm of FIG. 2 in accordance with aspects of the present disclosure;

FIG. 3B illustrates a second example embodiment of a system to use the algorithm of FIG. 2 in accordance with aspects of the present disclosure;

FIG. 3C illustrates a third example embodiment of a system to use the algorithm of FIG. 2 in accordance with aspects of the present disclosure;

FIG. 3D illustrates a fourth example embodiment of a system to use the algorithm of FIG. 2 in accordance with aspects of the present disclosure;

FIG. 4 illustrates the system of FIG. 3A with an exploded view of the vehicle navigation system (VNS) in accordance with aspects of the present disclosure;

FIG. 5 illustrates the system of FIG. 3B with an exploded view of the wireless device in accordance with aspects of the present disclosure;

FIG. 6 illustrates the system of FIG. 3C with an exploded view of the VNS and the wireless device in accordance with aspects of the present disclosure; and

FIG. 7 illustrates the system of FIG. 3D with an exploded view of the VNS and the wireless device in accordance with aspects of the present disclosure.

### DETAILED DESCRIPTION

Conventional automobile navigation systems enable users to plot a course to a destination. Further, many wireless devices, such as mobile phone and tablets include navigation systems such that these devices may be used by a user within an automobile to plot a course to a destination. The conventional systems use a GPS network to provide guidance and, sometimes, additional points of interest (POIs) for the user.

Unfortunately, a problem with conventional navigation systems is that some users may want to arrive at a destination, or point of interest, prior to sunset. This might be the case for seniors, who have trouble seeing clearly in the dark. This might also be the case for people traveling alone, who feel anxious arriving at a point of interest in the dark.

What is needed is a system and method for navigating a user to a destination or a point of interest before sunset.

A system and method in accordance with the present disclosure enable a user to be navigated to a destination or a point of interest before sunset.

In accordance with the present disclosure, a system uses navigation to assist users to find points-of-interest (POIs) before dark using a driving range-area. A driving range-area is modified using a back-off time value to obtain a modified driving range-area, wherein the back-off time value is subtracted from a sunset time. For example, an original driving range-area may be desired based on the time of sunset. For purposes of discussion let the back-off time value be 1 hour. As such, a modified driving range-area will be smaller than the original driving range-area based on the 1 hour decrease in available driving time.

This modified driving range-area may assist multiple types of users. In particular, the system assists operators to find points-of-interest before dark using a driving range-area. For example, a system and method in accordance with aspects of the present disclosure may assist seniors and older operators in low-light conditions.

The system helps seniors and older operators navigate in low-light conditions. For example, seniors who are driving on a road trip or in unfamiliar areas struggle driving in low-light situations. Sometimes, these operators may be towing cargo and need to find a campground for settling before dark. An operator during a road trip may also need a hotel before dark. As such, the system uses navigation to give operators options for points-of-interest according to certain parameters as the day ends. In this way, the system improves convenience and vehicle services to seniors and older operators.

Further, a system and method in accordance with aspects of the present disclosure may assist users looking for a hotel and traveling with a dog, wherein the dog may need to be walked for a while before sleeping in the hotel for the night. Further, a system and method in accordance with aspects of the present disclosure may assist users traveling alone and looking for a hotel. In these cases, the user may want to find and enter the hotel prior to sunset to increase their personal safety.

The system uses navigation configured to cast a driving range-area (e.g., circle, polygon, etc.) around a current position. In some embodiments, the system may be implemented in a vehicle, whereas in other embodiments, the system may be implemented in a wireless device carried by a user within a vehicle. The range-area may consider current route or potential driving roadways and updates the radius for sunset time. In some embodiments, the back-off time value may be 1 hour increments so operators can plan based on the time needed to setup camping, unpack, unload, and so on. However, in some embodiments, the back-off time value increment is operator specific and may be set by the user or preconfigured options. The profile (age, disability, etc.) of the operator may also be a factor to determine the increment and adjust the range-area. Furthermore, the system may warn the operator to leave a current place in order to arrive at a destination before dark.

In accordance with another aspect of the present disclosure, visibility may be determined based on weather, topography, elevation, etc. to factor with darkness for adjusting the back-off time value.

In accordance with another aspect of the present disclosure, the back-off time value may be modified based on buffer/setup time and stopping frequency, load (fueling/pace), etc.

In accordance with another aspect of the present disclosure, the back-off time value may be modified based on a current route, potential driving roadways, weather, and so on to update the radius of the driving range-area until dark.

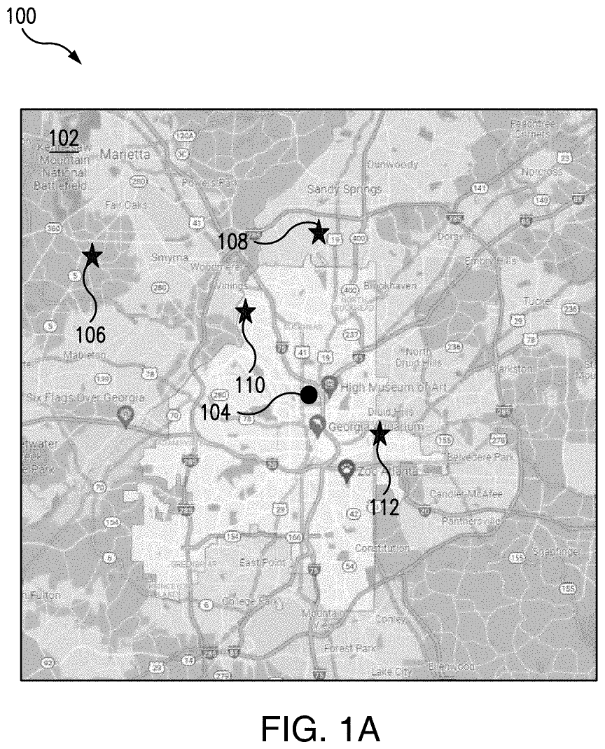

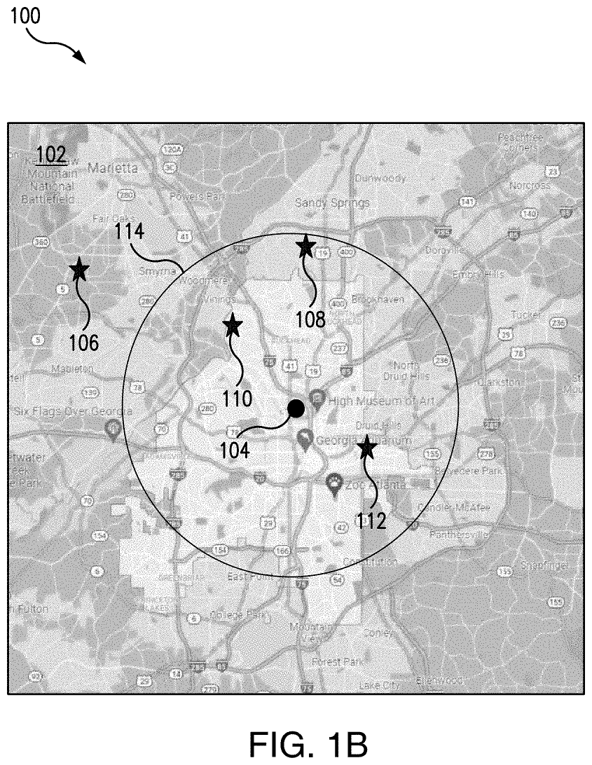

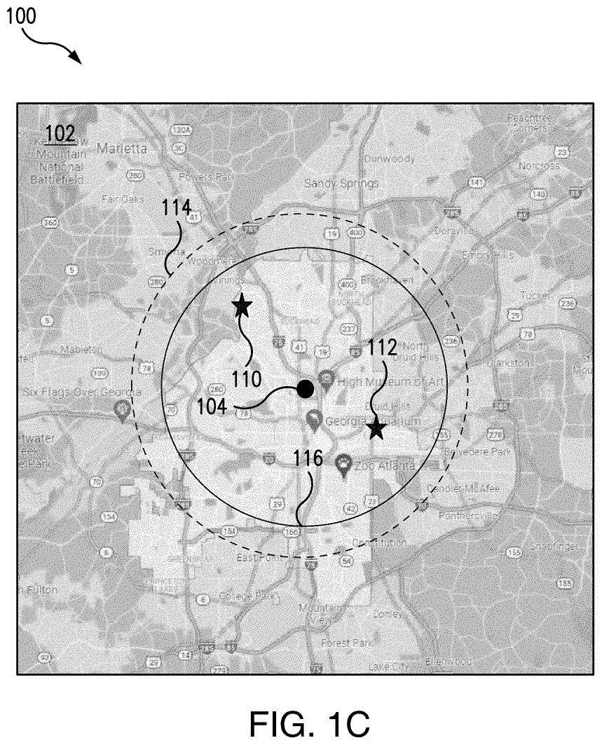

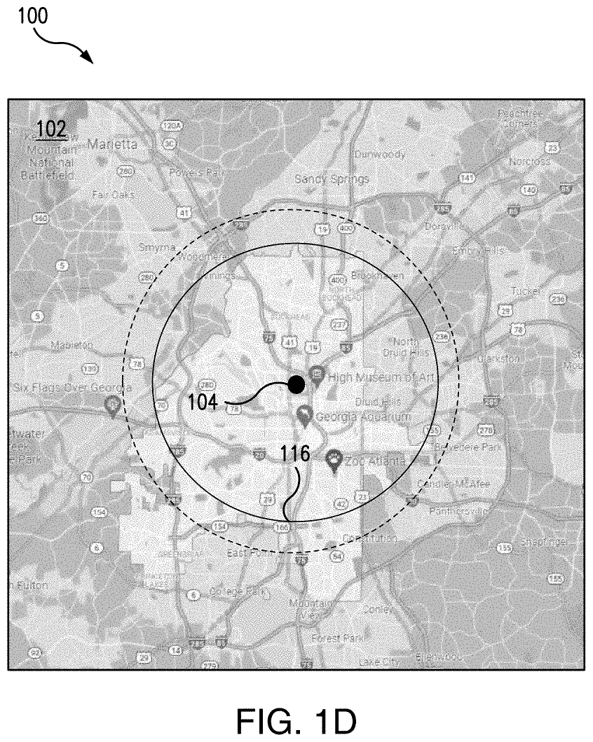

A system and method for modifying a driving range-area based on sunset in accordance with the present disclosure will now be described in greater detail with reference to FIGS. 1A-7.

FIG. 1A-D illustrate navigation maps in accordance with aspects of the present disclosure.

FIG. 1A illustrates an example navigation map 100. As shown in the figure, navigation map includes an area map 102, a device icon 104 centered on area map 102, and point of interest icons 106, 108, 110 and 112. Device icon 104 represents the location of the device implementing the navigation process in accordance with aspects of the present disclosure, e.g., a vehicle having a vehicle navigation system (VNS) or a wireless device within a vehicle.

FIG. 1B illustrates navigation map 100 of FIG. 1A with an initial driving range-area 114. As will be described in more detail below, initial driving range-area 114 is based on the area for which the device may travel until sundown. It should be noted that initial driving range-area 114 is represented as a circle merely for purposes of discussion. In example implementations, the actual initial driving range-area will not be circular, as the driving range is based on traffic patterns, which would lead to a non-circular area. Further, in the initial driving range-area may be illustrated using a polygon lattice.

FIG. 1C illustrates navigation map 100 of FIG. 1B with a modified driving range-area 116 based on a back-off time value and points of interest in accordance with aspects of the present disclosure. More specifically, as will be described in more detail below, in accordance with aspects of the present disclosure, initial driving range-area 114 is decreased to modified driving range-area 116. Accordingly, a user may be able to reach a destination within the modified driving range-area 116 prior to sunset. As

FIG. 1D illustrates navigation map 100 of FIG. 1B with modified driving range-area 116 based on a back-off time value without points of interest in accordance with aspects of the present disclosure. As will be described in more detail below, in some cases, there will be no points of interest within modified driving range-area 116. Nevertheless, a system and method in accordance with aspects of the present disclosure may still provide a user with a modified driving range-area map.

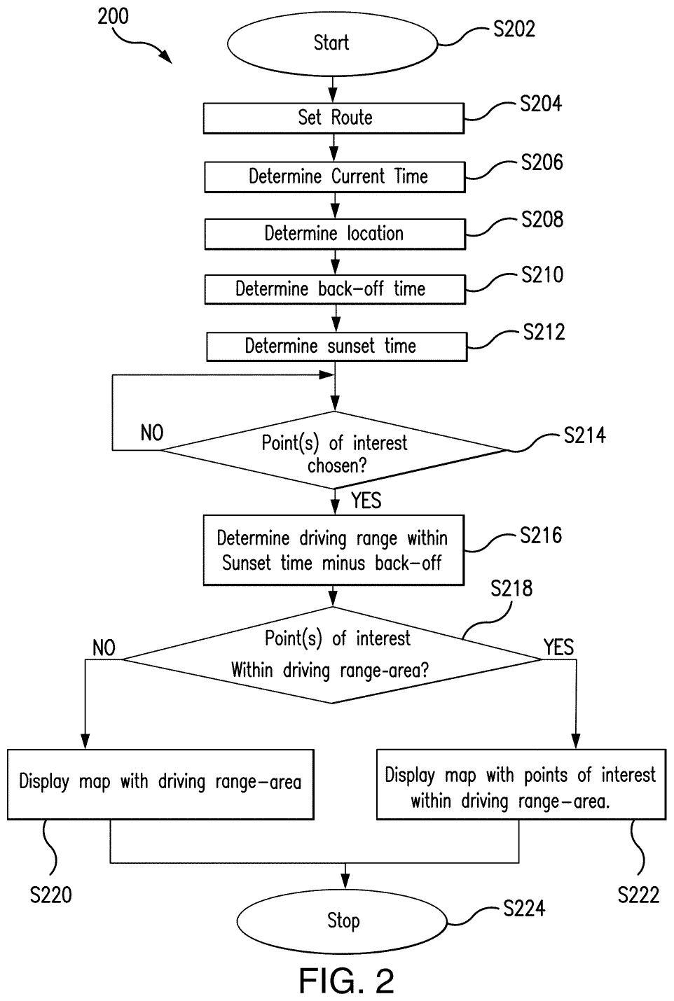

FIG. 2 illustrates an algorithm 200 to be executed by a processor in accordance with aspects of the present disclosure.

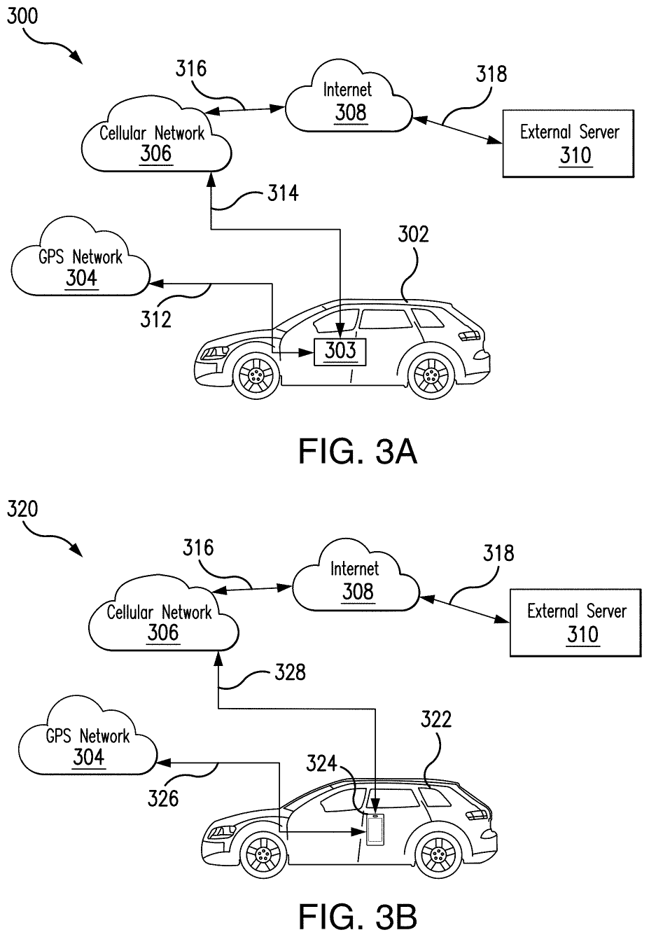

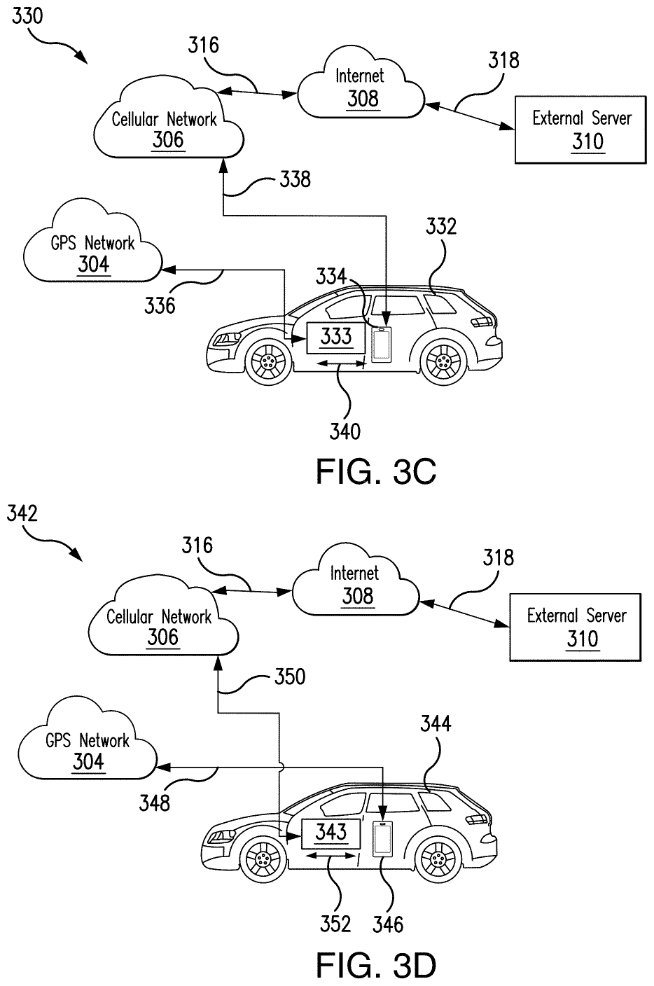

As shown in the figure, algorithm 200 starts (S202) and a route is set (S204). For example, a device or system may set a route from a GPS network. This will be described in greater detail with reference to FIGS. 3A-7.

FIG. 3A illustrates a first example embodiment of a system 300 to use algorithm 200 in accordance with aspects of the present disclosure, where a vehicle navigation system performs all processes of algorithm 200.

As shown in the figure, system 300 includes a vehicle 302, a GPS network 304, a cellular network 306, the Internet 308 and an external server 310. Vehicle 302 includes a vehicle navigation system (VNS) 303.

VNS 303 is configured to wirelessly communicate bidirectionally with GPS network 304 via a communication channel 312 and is configured to wirelessly communicate bidirectionally with cellular network 306 via a communication channel 314. Cellular network 306 is additionally configured to bidirectionally communicate with Internet 308 via a communication channel 316. Internet 308 is additionally configured to bidirectionally communicate with external server 310 via a communication channel 318.

GPS network 304 is a high-precision global navigation satellite system (GNSS) providing real-time corrections and data for post processing. A GNSS network consists of permanently located GPS receivers, installed across an area, that generate real-time, high-accuracy GPS positioning. GPS network 304 is configured to provide geodetic location data based on a geodetic location of a device. In this example GPS network 304 is configured to provide geodetic location data based on a geodetic location of VNS 303 within vehicle 302.

Further, GPS network 304 is configured to establish a route and estimated driving time associated with the route for VNS 303 based on a geodetic location of VNS 303 and a destination chosen by VNS 303. GPS network 304 may establish a route and estimated driving time by known GPS methods, non-limiting examples of which include Bayesian linear regression, decision forest regression, neural network regression, or combinations thereof.

For example, GPS network 304 may estimate the driving time associated with the route for VNS 303 based on stoppage frequency data and duration data of the stops accumulated from previous devices. As such, GPS network 304 may learn stoppage frequency and duration, for example during road trips or normal daily live, using a Bayesian linear regression. A Bayesian linear regression is an approach to regression used when predicting values. Regression itself makes forecasts by estimating the relationship between values and answers the types of questions, such as “how much or how many?”. Bayesian linear regression is a linear model and best suited for small data sets. When the regression model has errors that have a normal distribution, and if a particular form of prior distribution is assumed, explicit results are available for the posterior probability distributions of the model's parameters.

GPS network 304 may estimate the driving speed relative to the speed limit for VNS 303 during the route using a decision forest regression or a neural network regression. A decision forest regression is an approach to regression that is also used when predicting values. Decision forest regression is accurate and best suited for fast training times. A decision forest regression method operates by constructing a multitude of decision trees at training time. For classification tasks, the output of the decision forest is the class selected by most trees. For regression tasks, the mean or average prediction of the individual trees is returned. Random decision forests correct for decision trees' habit of overfitting to their training set.

Neural network regression is accurate and best suited for long training times. A neural network is a network of artificial neurons or nodes for solving artificial intelligence problems. The connections of nodes are modeled as weights between nodes. A positive weight reflects an excitatory connection, while negative values mean inhibitory connections. All inputs are modified by a weight and summed. This activity is referred to as a linear combination. Finally, an activation function controls the amplitude of the output. These artificial networks may be used for predictive modeling, adaptive control and applications where they can be trained via a dataset. Self-learning resulting from experience can occur within networks, which can derive conclusions from a complex and seemingly unrelated set of information.

GPS network 304 may estimate the vehicle and driver efficiency on a specific or different types of road using a decision forest regression or a neural network regression.

GPS network 304 may estimate heating, ventilation and air conditioning (HVAC) control usage under different scenes and seasons using a Bayesian linear regression.

Cellular network 306 is a communication network where the link to and from end nodes is wireless. The network is distributed over land areas called “cells,” each served by at least one fixed-location transceiver (typically three cell sites or base transceiver stations). These base stations provide the cell with the network coverage which can be used for transmission of voice, data, and other types of content. Major telecommunications providers have deployed voice and data cellular networks over most of the inhabited land area of Earth. This allows mobile phones and mobile computing devices to be connected to the public switched telephone network and public Internet access to Internet 308.

Internet 308 is the global system of interconnected computer networks that uses the Internet protocol suite (TCP/IP) to communicate between networks and devices.

External server 310 may take the form of a processor connected to a memory having data and instructions stored therein. The processor may execute the instructions within the memory to enable external server 310 to provide data and/or services to VNS 303 by way of Internet 308 and cellular network 306. In accordance with aspects of the present disclosure, external server 310 may provide current time data and sunset time data to VNS 303.

The current time data may include a current time value, wherein VNS 303 may determine a current time. The sunset time data may include a sunset time value, wherein VNS 303 may determine a sunset time. The sunset time value may be based on the geodetic location of VNS 303. For example, in the northern hemisphere, during the winter months, the sunset time value decreases as a function of the latitudinal lines—the sunset happens earlier as the latitude lines approach the north pole. Similarly, in the northern hemisphere, during the summer months, the sunset time value increases as a function of the latitudinal lines—the sunset happens later as the latitude lines approach the north pole.

VNS 303 may provide the geodetic location data as received from GPS network 304 to external server 310. Using the geodetic location data provided by VNS 303, external server 310 is configured to determine a sunset time value, and thereby return the sunset time data to VNS 303.

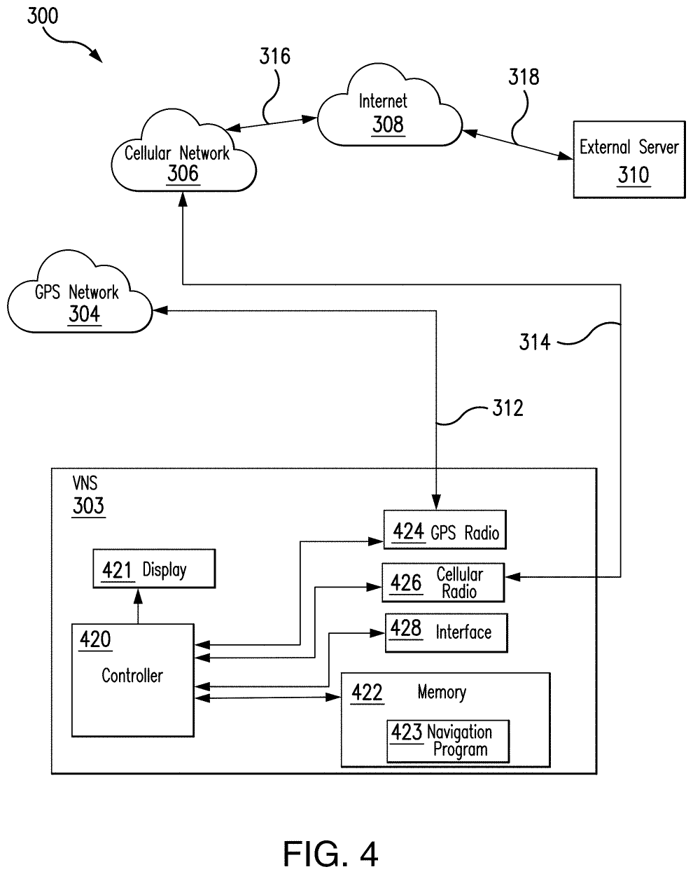

The operation of VNS 303 will be described in greater detail with reference to FIG. 4.

FIG. 4 illustrates system 300 with an exploded view of VNS 303.

As shown in the figure, VNS 303 includes a controller 420, a display 421, a memory 422, a GPS radio 424, a cellular radio 426, and a user interface circuit 428. Memory 422 includes a navigation program 423 stored therein, which includes instructions to be read by controller 420.

In this example, controller 420, display 421, memory 422, GPS radio 424, cellular radio 426, and interface circuit 428 are illustrated as individual devices. However, in some embodiments, at least two of controller 420, display 421, memory 422, GPS radio 424, cellular radio 426, and interface circuit 428 may be combined as a unitary device. Whether as individual devices or as combined devices, controller 420, display 421, memory 422, GPS radio 424, cellular radio 426, and interface circuit 428 may be implemented as any combination of an apparatus, a system and an integrated circuit. Further, in some embodiments, at least one of controller 420, memory 422, and interface circuit 428 may be implemented as a computer. The computer has a non-transitory computer-readable media for carrying or having computer-executable instructions or data structures stored thereon. Such non-transitory computer-readable recording medium refers to any computer program product, apparatus or device. Examples include such as a magnetic disk, optical disk, solid-state storage device, memory, programmable logic devices (PLDs), DRAM, RAM, ROM, EEPROM, CD-ROM. Other examples include other optical disk storage, magnetic disk storage or other magnetic storage devices. Other examples include any other medium that can be used to carry or store desired computer-readable program code. The code may be in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. Information may be transferred or provided over a network or another communications connection (either hardwired, wireless, or a combination of hardwired or wireless) to a computer. In such cases, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an integrated circuit (IC), an application specific integrated circuit (ASIC), or large-scale integrated circuit (LSI) that perform a part or all of the functions described herein. In the alternative, the processor and the tangible computer-readable media may reside as discrete components.

Example tangible computer-readable media may also be coupled to systems, examples of which include a computer system/server, which is operational with numerous other general purpose or special purpose computing system environments or configurations. Examples of well-known computing systems, environments, and/or configurations that may be suitable for use with computer system/server include personal computer systems. Additional examples include server computer systems, thin clients, thick clients, handheld or laptop devices, multiprocessor systems, microprocessor-based systems, and set-top boxes. Additional examples include programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. Such architectures include Industry Standard Architecture (ISA) bus, Micro Channel Architecture (MCA) bus, Enhanced ISA (EISA) bus. Such architectures additionally include Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. The operating system, one or more application programs, other program modules, and program data or some combination thereof, may include an implementation of a networking environment. The program modules generally carry out the functions and/or methodologies of various embodiments of the application as described herein.

Controller 420 is arranged to communicate with display 421 and to bidirectionally communicate with GPS radio 424, cellular radio 426, interface circuit 428 and memory 422.

Controller 420 may be implemented as a hardware processor for controlling the operation and functions of VNS 303 in accordance with the embodiments described in the present disclosure. Examples include a microprocessor, a multi-core processor, a single core processor, a field programmable gate array (FPGA), a microcontroller, and.an application specific integrated circuit (ASIC). Other examples include a digital signal processor (DSP), or other similar processing device capable of executing any type of instructions, algorithms, or software.

Display 421 may be any device or system that is configured to display image data to a user. Any known display device or system may be used in accordance with aspects of the present disclosure. Examples of displays include liquid crystal and light emitting diode displays.

Memory 422 can store various programming, and user content, and data, including navigation program 423. Navigation program 423 includes instructions, that when executed by controller 420, enable VNS 303 to perform processes in accordance with aspects of the present disclosure.

As will be described in greater details below, in some embodiments, navigation program 423 includes instructions, that when executed by controller 420, enable VNS 303 to receive geodetic location data and obtain a geodetic location of vehicle 302.

In these embodiments, navigation program 423 includes additional instructions, that when executed by controller 420, enable VNS 303 to receive current time data and obtain the current time. In these embodiments, navigation program 423 includes additional instructions, that when executed by controller 420, enable VNS 303 to receive a sunset time data and obtain the sunset time.

In these embodiments, navigation program 423 includes additional instructions, that when executed by controller 420, enable VNS 303 to determine a driving range-area based on the sunset time, the current time, and the geodetic location. In these embodiments, navigation program 423 includes additional instructions, that when executed by controller 420, enable VNS 303 to instruct display 421 to display a modified map. In these embodiments, the modified map includes a modified driving-range area based on the geodetic location, the current time and the sunset time.

As will be described in greater details below, in some embodiments, the modified map further includes a driving-range area based on the geodetic location and the current time. Further, in these embodiments, the driving-range area is smaller than the modified driving-range area.

In some embodiments, navigation program 423 includes additional instructions, that when executed by controller 420, enable VNS 303 to establish a back-off time value. In these embodiments, the modified map includes a modified driving-range area based on the geodetic location, the current time, the sunset time and the back-off time value.

In some embodiments, navigation program 423 includes additional instructions, that when executed by controller 420, enable VNS 303 to enable, via interface circuit 428, a user to change the back-off time value. In some of these embodiments, navigation program 423 includes additional instructions, that when executed by controller 420, enable controller 420 to instruct interface circuit 428 to enable functions. The functions include enabling the user to change the back-off time value in one-hour increments. Further, in some embodiments, navigation program 423 includes additional instructions, that when executed by controller 420, enable controller 420 to enable other functions. The other function includes enabling, via interface circuit 429, the user to search for points-of-interest within the modified map.

GPS radio 424, may also be referred to as a wireless communication circuit, such as a GPS interface radio transceiver and is configured to wirelessly communicate with GPS network 304 via wireless communication channel 312. GPS radio 424 includes one or more antennas and communicates wirelessly via one or more of the L1 through L5 bands, or at the appropriate band and bandwidth to implement any GPS protocols.

Cellular radio 426, may also be referred to as a wireless communication circuit, such as a cellular interface radio transceiver and is configured to wirelessly communicate with cellular network 306 via wireless communication channel 314. Cellular radio 426 includes at least one antenna and communicates wirelessly via at least of the wireless cellular bands, or at the appropriate band and bandwidth to implement any 2G, 3G, 4G, and 5G protocols.

Interface circuit 428 may be any device or system that is configured to enable a user to access and control controller 420. Interface circuit 428 may include one or more layers. The layers may include a human-machine interface (HMI) machines with physical input hardware such a keyboards, mice, game pads and output hardware such as computer monitors, speakers, and printers. Additional user interface layers in interface circuit 428 may interact with one or more human senses, including: tactile user interface (touch), visual user interface (sight), and auditory user interface (sound).

In operation, controller 420 executes instructions within navigation program 423 to instruct interface circuit 428, GPS radio 424 and display 421 to enable a user to set a route to drive. This may be performed by any known navigation method and include. For example, controller 420 may instruct GPS radio 424 to contact GPS network 304 and obtain map data by known protocols. Controller 420 may instruct display 421 to display a map to the user based on the obtained map data. Further controller 420 may instruct interface circuit 428 to enable the user to choose a destination. Controller 420 may then instruct GPS radio 424 to contact GPS network 304 and obtain route data based on the chosen destination. Controller 420 may instruct display 421 to display a route on the map to the user based on the obtained route data.

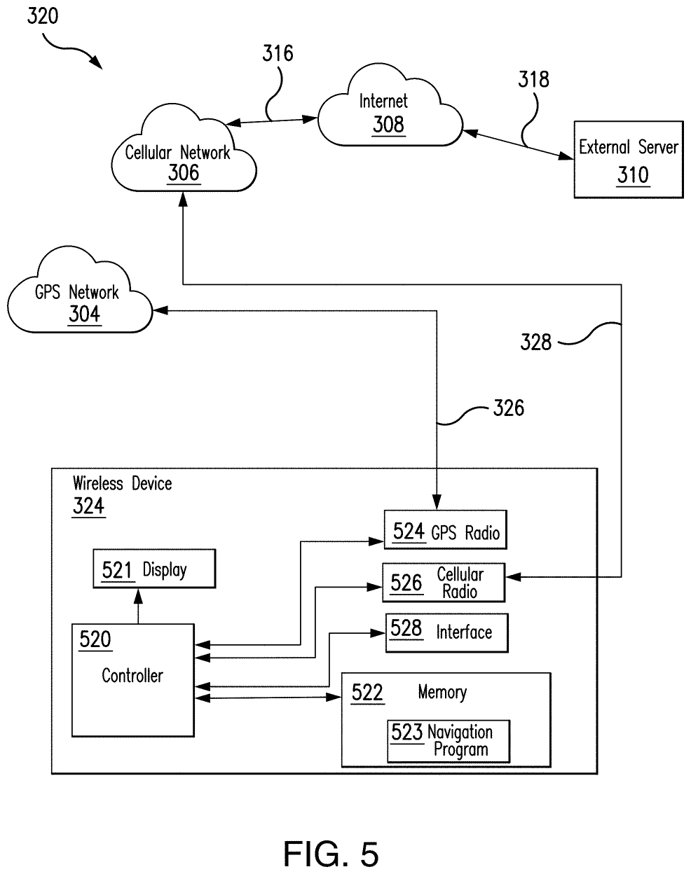

In the embodiment discussed above with reference to FIG. 4, VNS 303 enables a user to set a route. However, in other embodiments, a wireless device of a user riding in a vehicle may enable the user to set a route. This will be described in greater detail with reference to FIGS. 3B and 5.

FIG. 3B illustrates a second example embodiment of a system 320 to use algorithm 200 in accordance with aspects of the present disclosure, wherein a wireless device within a vehicle performs all processes of algorithm 200.

As shown in the figure, system 320 includes a vehicle 322, GPS network 304, cellular network 306, the Internet 308 and external server 310. Vehicle 322 includes a wireless communication device 324.

System 320 is somewhat similar to system 300 discussed above with reference to FIG. 3A. However, system 320 differs from system 300 in that in system 320, wireless communication device 324 is configured to wirelessly communicate bidirectionally with GPS network 304 via a communication channel 312. Further, system 320 is additionally configured to wirelessly communicate bidirectionally with cellular network 306 via a communication channel 314.

FIG. 5 illustrates system 320 with an exploded view of wireless device 324.

As shown in the figure, wireless device 324 includes a controller 520, a display 521, a memory 522, a GPS radio 524, a cellular radio 526, and a user interface circuit 528. Memory 522 includes a navigation program 523 stored therein, which includes instructions to be read by controller 520.

In this example, controller 520, display 521, memory 522, GPS radio 524, cellular radio 526, and interface circuit 528 are illustrated as individual devices. However, in some embodiments, at least two of controller 520, display 521, memory 522, GPS radio 524, cellular radio 526, and interface circuit 528 may be combined as a unitary device. Controller 520, display 521, memory 522, GPS radio 524, cellular radio 526, and interface circuit 528 may be implemented as any combination of an apparatus, a system and an integrated circuit. Further, in some embodiments, at least one of controller 520, memory 522, and interface circuit 528 may be implemented as a computer having non-transitory computer-readable media for carrying or having computer-executable instructions stored thereon.

Controller 520 is arranged to communicate with display 521 and to bidirectionally communicate with GPS radio 524, cellular radio 526, interface circuit 528 and memory 522.

Controller 520 may be implemented as a hardware processor for controlling the operation and functions of wireless device 324 in accordance with the embodiments described in the present disclosure.

Display 521 may be any device or system that is configured to display image data to a user.

Memory 522 can store various programming, and user content, and data, including navigation program 523. Navigation program 523 is somewhat similar to navigation program 423 discussed above with reference to FIG. 4. However, navigation program 523 includes instructions, that when executed by controller 520, enable wireless device 324 to perform processes in accordance with aspects of the present disclosure.

GPS radio 524 has a similar structure and operates in a similar manner to GPS radio 424 discussed above with reference to FIG. 4. However, GPS radio 524 is configured to wirelessly communicate with GPS network 304 via wireless communication channel 326.

Cellular radio 526 has a similar structure and operates in a similar manner to cellular 426 discussed above with reference to FIG. 4. However, cellular radio 526 is configured to wirelessly communicate with cellular network 306 via wireless communication channel 328.

Interface circuit 528 has a similar structure and operates in a similar manner to interface circuit 428 discussed above with reference to FIG. 4. However, interface circuit 528 is configured to enable a user to access and control controller 520.

In operation, controller 520 executes instructions within navigation program 523 to instruct interface circuit 528, GPS radio 524 and display 521 to enable a user to set a route to drive. This may be performed by any known navigation method and include. For example, controller 520 may instruct GPS radio 524 to contact GPS network 304 and obtain map data by known protocols. Controller 520 may instruct display 521 to display a map to the user based on the obtained map data. Further controller 520 may instruct interface circuit 528 to enable the user to choose a destination. Controller 520 may then instruct GPS radio 524 to contact GPS network 304 and obtain route data based on the chosen destination. Controller 520 may instruct display 521 to display a route on the map to the user based on the obtained route data.

Returning to FIG. 2, after the route is determined (S204), a current time is determined (S206). For example, a device or system may determine a current time from either GPS network 304 or external server 310.

In the example embodiment shown in FIG. 3A, in some embodiments, VNS 303 may obtain a current time from GPS network 304, whereas in other embodiments, VNS 303 may obtain the current time from external server 310. These two optional embodiments will be further described in greater detail with reference to FIG. 4.

As shown in FIG. 4, in operation of one embodiment, VNS 303 obtains the current time from GPS network 304. In particular, controller 420 executes instructions within navigation program 423 to instruct GPS radio 424 to contact GPS network 304 and obtain the current time. GPS network 304 then provides the current time to controller 420 via GPS radio 426. Once the current time is known, an internal clock (not shown) in controller 420 may be able to accurately maintain the current time.

In operation of another embodiment, VNS 303 obtains the current time from external server 310. In particular, controller 420 executes instructions within navigation program 423 to instruct cellular radio 426 to contact external server 310, via cellular network 306 and internet 308. External server 310 then provides the current time to controller 420 via internet 308, cellular network 306, and cellular radio 426. Once the current time is known, an internal clock (not shown) in controller 420 may be able to accurately maintain the current time.

In the example embodiment shown in FIG. 3B, in some embodiments, wireless device 324 may obtain a current time from GPS network 304, whereas in other embodiments, wireless device 324 may obtain the current time from external server 310. These two optional embodiments will be further described in greater detail with reference to FIG. 5.

As shown in FIG. 5, in operation of one embodiment, wireless device 324 obtains the current time from GPS network 304. In particular, controller 520 executes instructions within navigation program 523 to instruct GPS radio 524 to contact GPS network 304 and obtain the current time. GPS network 304 then provides the current time to controller 520 via GPS radio 526. Once the current time is known, an internal clock (not shown) in controller 520 may be able to accurately maintain the current time.

In operation of another embodiment, wireless device 324 obtains the current time from external server 310. In particular, controller 520 executes instructions within navigation program 523 to instruct cellular radio 526 to contact external server 310, via cellular network 306 and internet 308. External server 310 then provides the current time to controller 520 via internet 308, cellular network 306, and cellular radio 526. Once the current time is known, an internal clock (not shown) in controller 520 may be able to accurately maintain the current time.

In the example embodiments discussed above with reference to FIGS. 3A-B, 4 and 5, a single device—either VNS 303 or wireless device 324—obtains information from both GPS network 304 and external server 310. However, in other embodiments, a VNS obtains information from one of GPS network 304 and external server 310, whereas another device obtains information from the other of GPS network 304 and external server 310. These embodiments will now be described with reference to FIGS. 3C-D, 6 and 7.

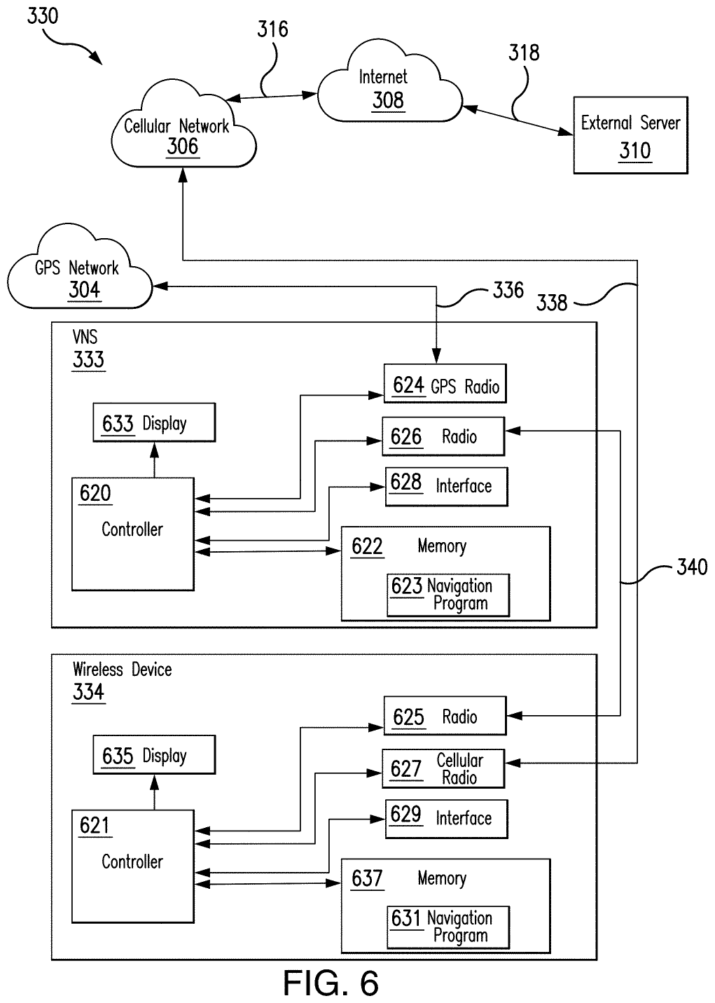

In a third example embodiment, a VNS obtains GPS related data whereas a wireless device obtains other data. This will be described in greater detail with reference to FIGS. 3C and 6.

FIG. 3C illustrates the third example embodiment of a system 330 to use algorithm 200 in accordance with aspects of the present disclosure. In this example, a vehicle navigation system performs processes of algorithm 200 related to GPS information, whereas a wireless device within the vehicle performs other processes of algorithm 200.

As shown in the figure, system 330 includes a vehicle 332, GPS network 304, cellular network 306, the Internet 308 and external server 310. Vehicle 332 includes a VNS 333 and a wireless communication device 334.

System 330 is somewhat similar to system 300 discussed above with reference to FIG. 3A. However, system 330 differs from system 300 in that in system 330, VNS 333 is configured to wirelessly communicate bidirectionally with GPS network 304 via a communication channel 336. Further, wireless communication device 334 is configured to wirelessly communicate bidirectionally with cellular network 306 via a communication channel 338. Still further, VNS 333 is additionally configured to wirelessly communicate bidirectionally with wireless communication device 334 via a wireless communication channel 340. Additionally, wireless communication device 334 is configured to wirelessly communicate bidirectionally with VNS 333 via wireless communication channel 340.

FIG. 6 illustrates system 330 with an exploded view of VNS 333 and an exploded view of wireless device 334.

As shown in the figure, VNS 333 includes a controller 620, a display 633, a memory 622, a GPS radio 624, a radio 626, and a user interface circuit 628. Memory 622 includes a navigation program 623 stored therein, which includes instructions to be read by controller 620. Further, wireless device 334 includes a controller 621, a display 635, a memory 637, a radio 625, a cellular radio 627, and a user interface circuit 629. Memory 637 includes a navigation program 631 stored therein, which includes instructions to be read by controller 621

In this example, controller 620, display 633, memory 622, GPS radio 624, radio 626, and interface circuit 628 are illustrated as individual devices. However, in some embodiments, at least two of controller 620, display 633, memory 622, GPS radio 624, radio 626, and interface circuit 628 may be combined as a unitary device. Controller 620, display 633, memory 622, GPS radio 624, radio 626, and interface circuit 628 may be implemented as any combination of an apparatus, a system and an integrated circuit. Further, in some embodiments, at least one of controller 620, memory 622, and interface circuit 628 may be implemented as a computer. The computer may have non-transitory computer-readable media for carrying or having computer-executable instructions or data structures stored thereon.

Controller 620 is arranged to communicate with display 633 and to bidirectionally communicate with GPS radio 624, radio 626, interface circuit 628 and memory 622. GPS radio 624 is configured to bidirectionally wirelessly communicate with GPS network 304 via wireless communication channel 336. Radio 626 is configured to bidirectionally communicate with wireless device 334 via wireless communication channel 340.

Controller 620 may be implemented as a hardware processor for controlling the operation and functions of VNS 333 in accordance with the embodiments described in the present disclosure.

Display 633 may be any device or system that is configured to display image data to a user.

Memory 622 can store various programming, and user content, and data, including navigation program 623. Navigation program 623 is somewhat similar to navigation program 423 discussed above with reference to FIG. 4. However, navigation program 623 includes instructions, that when executed by controller 620, enable VNS 333 to perform processes in accordance with aspects of the present disclosure. In particular, navigation program 623 differs from navigation program 423, in that navigation program 623 does not deal with issues related to cellular network 306.

GPS radio 624 has a similar structure and operates in a similar manner to GPS radio 424 discussed above with reference to FIG. 4. However, GPS radio 524 is configured to wirelessly communicate with GPS network 304 via wireless communication channel 326.

Radio 626 may include a Wi-Fi WLAN interface radio transceiver that is configured to wirelessly communicate with wireless device 334 via wireless communication channel 340. Radio 626 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols. Such IEEE 802.11 Wi-Fi protocols include the Wi-Fi 4, 5, 6, or 6E protocols. Radio 626 can also be equipped with a radio transceiver/wireless communication circuit to implement a wireless connection in accordance with other protocols. Such other protocols include any Bluetooth protocols, Bluetooth Low Energy (BLE). Other protocols include other short-range protocols that operate in accordance with a wireless technology standard for exchanging data over short distances using any licensed or unlicensed band. Such licensed bands include the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface circuit 628 has a similar structure and operates in a similar manner to interface circuit 428 discussed above with reference to FIG. 4. However, interface circuit 628 is configured to enable a user to access and control controller 620.

In this example, controller 621, display 635, memory 637, radio 625, cellular radio 627, and interface circuit 629 are illustrated as individual devices. However, in some embodiments, at least two of controller 621, display 635, memory 637, radio 625, cellular radio 627, and interface circuit 629 may be combined as a unitary device. Controller 621, display 635, memory 637, radio 625, cellular radio 627, and interface circuit 629 may be implemented as any combination of an apparatus, a system and an integrated circuit. Further, in some embodiments, at least one of controller 621, memory 637, and interface circuit 629 may be implemented as a computer. The computer may have non-transitory computer-readable media for carrying or having computer-executable instructions or data structures stored thereon.

Controller 621 is arranged to communicate with display 635 and to bidirectionally communicate with radio 625, cellular radio 627, interface circuit 629 and memory 637. Radio 625 is configured to bidirectionally wirelessly communicate with radio 626 of VNS 333 via wireless communication channel 340. Cellular radio 627 is configured to bidirectionally wirelessly communicate with cellular network 306 via wireless communication channel 338.

Controller 621 may be implemented as a hardware processor for controlling the operation and functions of wireless device 334 in accordance with the embodiments described in the present disclosure.

Display 635 may be any device or system that is configured to display image data to a user.

Memory 637 can store various programming, and user content, and data, including navigation program 631. Navigation program 631 is somewhat similar to navigation program 523 discussed above with reference to FIG. 5. However, navigation program 631 includes instructions, that when executed by controller 621, enable wireless device 334 to perform processes in accordance with aspects of the present disclosure. In particular, navigation program 631 differs from navigation program 523, in that navigation program 631 deals with GPS data received from VNS 333.

Cellular radio 627 has a similar structure and operates in a similar manner to cellular radio 526 discussed above with reference to FIG. 5. However, cellular radio 627 is configured to wirelessly communicate with cellular network 306 via wireless communication channel 338.

Radio 625 has a similar structure and operates in a similar manner to radio 626 in VNS 333.

Interface circuit 629 has a similar structure and operates in a similar manner to interface circuit 528 discussed above with reference to FIG. 5. However, interface circuit 629 is configured to enable a user to access and control controller 621.

As shown in FIG. 6, in operation of one embodiment, VNS 333 obtains information from GPS network 304, whereas wireless device 334 obtains information from external server 310. In other words, in this embodiments, VNS 333 and wireless device 334 work in tandem to perform the processes of algorithm 200.

In particular, VNS 333 is configured to enable a user to set a route (S204), whereas wireless device 334 is configured to determine the current time (S206).

More specifically, as shown in FIG. 6, in operation, controller 620 of VNS 333 executes instructions within navigation program 623 to instruct interface circuit 628, GPS radio 624 and display 633 to enable a user to set a route to drive. This may be performed in a manner similar to that discussed above with reference to FIG. 4. Further, controller 621 executes instructions within navigation program 631 to instruct cellular radio 627 to contact external server 310, via cellular network 306 and internet 308. External server 310 then provides the current time to controller 621 of wireless device 334 via internet 308, cellular network 306, and cellular radio 426.

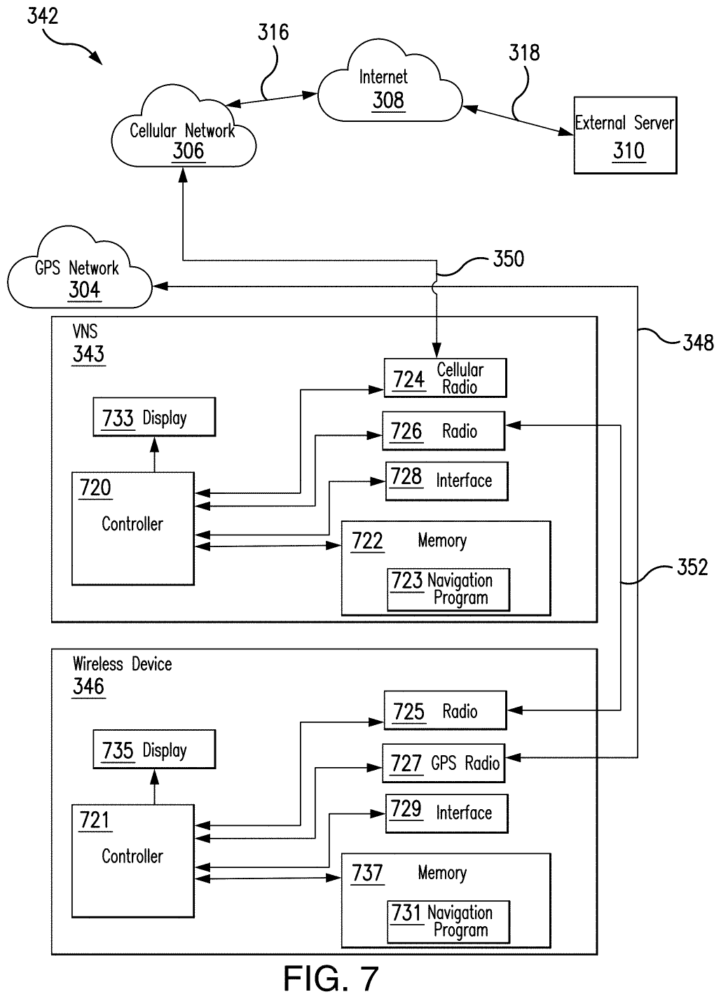

In a fourth example embodiment, a wireless device obtains GPS related data whereas a VNS obtains other data. This will be described in greater detail with reference to FIGS. 3D and 7.

FIG. 3D illustrates a fourth example embodiment of a system 342 to use algorithm 200 in accordance with aspects of the present disclosure. In this example, a wireless device within a vehicle performs processes of algorithm 200 related to GPS information, whereas a VNS within the vehicle performs other processes of algorithm 200.

As shown in the figure, system 342 includes a vehicle 344, GPS network 304, cellular network 306, the Internet 308 and external server 310. Vehicle 344 includes a VNS 343 and a wireless communication device 346.

System 342 is somewhat similar to system 330 discussed above with reference to FIG. 3C. However, system 342 differs from system 330 in that in system 342, wireless communication device 346 is configured to wirelessly communicate bidirectionally with GPS network 304 via a communication channel 348. VNS 343 is configured to wirelessly communicate bidirectionally with cellular network 306 via a communication channel 350. Further, VNS 343 is additionally configured to wirelessly communicate bidirectionally with wireless communication device 346 via a communication channel 352. Wireless communication device 346 is additionally configured to wirelessly communicate bidirectionally with VNS 343 via communication channel 352

FIG. 7 illustrates system 342 with an exploded view of VNS 343 and an exploded view of wireless device 346.

As shown in the figure, VNS 343 includes a controller 720, a display 733, a memory 722, a cellular radio 724, a radio 726, and a user interface circuit 728. Memory 722 includes a navigation program 723 stored therein, which includes instructions to be read by controller 720. Further, wireless device 346 includes a controller 721, a display 735, a memory 737, a radio 725, a GPS radio 727, and a user interface circuit 729. Memory 737 includes a navigation program 731 stored therein, which includes instructions to be read by controller 721.

In this example, controller 720, display 733, memory 722, cellular radio 724, radio 726, and interface circuit 728 are illustrated as individual devices. However, in some embodiments, at least two of controller 720, display 733, memory 722, cellular radio 724, radio 726, and interface circuit 728 may be combined as a unitary device. Controller 720, display 733, memory 722, cellular radio 724, radio 726, and interface circuit 728 may be implemented as any combination of an apparatus, a system and an integrated circuit. Further, in some embodiments, at least one of controller 720, memory 722, and interface circuit 728 may be implemented as a computer. The computer may have non-transitory computer-readable media for carrying or having computer-executable instructions or data structures stored thereon.

Controller 720 is arranged to communicate with display 733 and to bidirectionally communicate with cellular radio 724, radio 726, interface circuit 728 and memory 722. Cellular radio 724 is configured to bidirectionally wirelessly communicate with cellular network 306 via wireless communication channel 350. Radio 726 is configured to bidirectionally communicate with wireless device 346 via wireless communication channel 352.

Controller 720 may be implemented as a hardware processor for controlling the operation and functions of VNS 343 in accordance with the embodiments described in the present disclosure.

Display 733 may be any device or system that is configured to display image data to a user.

Memory 722 can store various programming, and user content, and data, including navigation program 723. Navigation program 723 is somewhat similar to navigation program 423 discussed above with reference to FIG. 4. However, navigation program 723 includes instructions, that when executed by controller 620, enable VNS 343 to perform processes in accordance with aspects of the present disclosure. In particular, navigation program 723 differs from navigation program 423, in that navigation program 723 deals with GPS data as received from wireless device 346.

Cellular radio 724 has a similar structure and operates in a similar manner to cellular radio 426 discussed above with reference to FIG. 4. However, cellular radio 724 is configured to wirelessly communicate with cellular network 306 via wireless communication channel 350.

Radio 726 has a similar structure and operates in a similar manner to radio 626 in VNS 333 discussed above with reference to FIG. 6.

Interface circuit 728 has a similar structure and operates in a similar manner to interface circuit 628 discussed above with reference to FIG. 6. However, interface circuit 728 is configured to enable a user to access and control controller 720.

Controller 721, display 735, memory 737, radio 725, GPS radio 727, and interface circuit 729 are illustrated as individual devices. However, in some embodiments, at least two of controller 721, display 735, memory 737, radio 725, GPS radio 727, and interface circuit 729 may be combined as a unitary device. Controller 721, display 735, memory 737, radio 725, GPS radio 727, and interface circuit 729 may be implemented as any combination of an apparatus, a system and an integrated circuit. Further, in some embodiments, at least one of controller 721, memory 737, and interface circuit 729 may be implemented as a computer. The computer may have non-transitory computer-readable media for carrying or having computer-executable instructions or data structures stored thereon.

Controller 721 is arranged to communicate with display 735 and to bidirectionally communicate with radio 725, GPS radio 727, interface circuit 729 and memory 737. Radio 725 is configured to bidirectionally wirelessly communicate with radio 726 of VNS 343 via wireless communication channel 352. GPS radio 727 is configured to bidirectionally wirelessly communicate with GPS network 304 via wireless communication channel 348.

Controller 721 may be implemented as a hardware processor for controlling the operation and functions of wireless device 346 in accordance with the embodiments described in the present disclosure.

Display 735 may be any device or system that is configured to display image data to a user.

Memory 737 can store various programming, and user content, and data, including navigation program 731. Navigation program 731 is somewhat similar to navigation program 423 discussed above with reference to FIG. 4. However, navigation program 731 includes instructions, that when executed by controller 721, enable wireless device 346 to perform processes in accordance with aspects of the present disclosure. In particular, navigation program 731 differs from navigation program 423, in that navigation program 731 does not deal with issues related to cellular network 306.

GPS radio 727 has a similar structure and operates in a similar manner to GPS radio 524 discussed above with reference to FIG. 5. However, GPS radio 727 is configured to wirelessly communicate with GPS network 304 via wireless communication channel 348.

Radio 725 has a similar structure and operates in a similar manner to radio 627 in wireless device 334.

Interface circuit 729 has a similar structure and operates in a similar manner to interface circuit 528 discussed above with reference to FIG. 5. However, interface circuit 729 is configured to enable a user to access and control controller 721.

As shown in FIG. 7, in operation of one embodiment, wireless device 346 obtains information from GPS network 304, whereas VNS 343 obtains information from external server 310. In other words, in these embodiments, VNS 343 and wireless device 346 also work in tandem to perform the processes of algorithm 200.

In particular, wireless device 346 is configured to enable a user to set a route (S204), whereas VNS 343 is configured to determine the current time (S206).

More specifically, as shown in FIG. 7, in operation, controller 721 of wireless device 346 executes instructions within navigation program 731 to instruct interface circuit 729, GPS radio 727 and display 735 to enable a user to set a route to drive. This may be performed in a manner similar to that discussed above with reference to FIG. 5. Further, controller 720 executes instructions within navigation program 723 to instruct cellular radio 724 to contact external server 310, via cellular network 306 and internet 308. External server 310 then provides the current time to controller 720 of VNS 343 via internet 308, cellular network 306, and cellular radio 426.

Returning to FIG. 2, after a current time is determined (S206), a location is determined (S208). In some embodiments, a VNS may determine a location, whereas in other embodiments, a wireless device may determine a location.

An embodiment wherein a VNS determines a location will be described with reference to FIG. 4. As shown in the figure, controller 420 may execute instructions in navigation program 423 to instruct GPS radio 424 to request location data from GPS network 304. In response, GPS network 304 may provide the location data, associated with the location of VNS 303 to GPS radio 424, which in turn will provide the location data to controller 420. Controller 420 may then analyze the received location data to determine the location of VNS 303.

VNS 333 discussed above with reference to FIG. 6 may operate in a similar manner.

An embodiment wherein a wireless device determines a location will be described with reference to FIG. 5. As shown in the figure, controller 520 may execute instructions in navigation program 523 to instruct GPS radio 524 to request location data from GPS network 304. In response, GPS network 304 may provide the location data, associated with the location of wireless device 324 to GPS radio 524, which in turn will provide the location data to controller 520. Controller 520 may then analyze the received location data to determine the location of wireless device 324.

Wireless device 340 discussed above with reference to FIG. 7 may operate in a similar manner.

Returning to FIG. 2, after a location is determined (S208), a back-off time value is determined (S210). In some embodiments, a VNS may determine a back-off time value, whereas in other embodiments, a wireless device may determine a back-off time value.

An embodiment wherein a VNS determines a back-off time value will be described with reference to FIG. 4. A default back-off time value may be stored in navigation program 423. As such, controller 420 may retrieve the back-off time value from navigation program 423. In some of these embodiments, controller 420 may execute instructions in navigation program 423 to instruct interface 428 and display 421 to enable a user to alter the default back-off time value. In some of these embodiments, user may be able to alter the default back-off time value by predetermined increments of time, for example, 1-hour increments. Controller 420 may then overwrite the default back-off time value in navigation program 423 with the altered back-off time value.

In embodiments, of the embodiments discussed above with reference to FIG. 6, wherein VNS 333 determines a back-off time value, VNS 333 may operate in a similar manner. Further, in embodiments, of the embodiments discussed above with reference to FIG. 7, wherein VNS 343 determines a back-off time value, VNS 343 may additionally operate in a similar manner.

An embodiment wherein a wireless device determines a back-off time value will be described with reference to FIG. 5. A default back-off time value may be stored in navigation program 523. As such, controller 520 may retrieve the back-off time value from navigation program 523. In some of these embodiments, controller 520 may execute instructions in navigation program 523 to instruct interface 528 and display 521 to enable a user to alter the default back-off time value. In some of these embodiments, user may be able to alter the default back-off time value by predetermined increments of time, for example, 1-hour increments. Controller 520 may then overwrite the default back-off time value in navigation program 523 with the altered back-off time value.

In embodiments, of the embodiments discussed above with reference to FIG. 6, wherein wireless device 334 determines a back-off time value, wireless device 334 may operate in a similar manner. Further, in embodiments, of the embodiments discussed above with reference to FIG. 7, wherein wireless device 346 determines a back-off time value, wireless device 346 may additionally operate in a similar manner.

Returning to FIG. 2, after a back-off time value is determined (S210), a sunset is determined (S212). In some embodiments, GPS network 304 may provide the sunset time. In some embodiments, external server 310 may provide the sunset time. In some embodiments, the VNS may determine the sunset time. In some embodiments, the wireless device may determine the sunset time.

In those embodiments wherein GPS network 304 provides the sunset time, GPS network 304 may include a data structure, such as a lookup table that associates the location of the device with a respective sunset time. In these embodiments, the determination of the sunset time is offloaded to GPS network 304. For example, as shown in FIG. 4, when GPS network 304 provides geodetic location data (S208) to VNS 303, GPS network 304 may additionally determine the sunset time associated with the location of VNS 303. As such, GPS network 304 may additionally provide the sunset time data that includes a sunset time value to VNS 303 via communication channel 312. GPS radio 424 may receive the sunset time data and provide the sunset time data to controller 420. Controller 420 may then analyze the sunset time data to obtain the sunset time value, which is associated with the geodetic location of VNS 303. Controller 420 may then store the sunset time value in memory 422.

Similarly, as shown in FIG. 5, when GPS network 304 provides geodetic location data (S208) to wireless device 324, GPS network 304 may additionally determine the sunset time. In this instance the sunset time is associated with the location of wireless device 324. As such, GPS network 304 may additionally provide the sunset time data that includes a sunset time value to wireless device 324 via communication channel 326. GPS radio 524 may receive the sunset time data and provide the sunset time data to controller 520. Controller 520 may then analyze the sunset time data to obtain the sunset time value, which is associated with the geodetic location of wireless device 324. Controller 520 may then store the sunset time value in memory 522.

In those embodiments wherein external server 310 provides the sunset time, external server 310 may include a data structure, such as a lookup table that associates the location of the device with a respective sunset time. In these embodiments, the determination of the sunset time is offloaded to external server 310. For example, as shown in FIG. 4, after GPS network 304 provides geodetic location data (S208) to VNS 303, VNS 303 may provide its geodetic location to external server 310. In particular, controller 420 may executed instructions in navigation program 423 to instruct cellular radio 426 to transmit its geodetic location data to external server 310. As such, external server 310 will receive the geodetic location data via cellular network 306 and Internet 308. In accordance with the data structure within external server, the sunset time is associated with the location of VNS 303. As such, external server 310 may provide the sunset time data that includes a sunset time value to VNS 303 via Internet 308 and cellular network 306. Cellular radio 426 may receive the sunset time data and provide the sunset time data to controller 420. Controller 420 may then analyze the sunset time data to obtain the sunset time value, which is associated with the geodetic location of VNS 303. Controller 420 may then store the sunset time value in memory 422.

Similarly, as shown in FIG. 5, after GPS network 304 provides geodetic location data (S208) to wireless device 324, wireless device 324 may provide its geodetic location to external server 310. Controller 520 may execute instructions in navigation program 523 to instruct cellular radio 526 to transmit its geodetic location data to external server 310. As such, external server 310 will receive the geodetic location data via cellular network 306 and Internet 308. In accordance with the data structure within external server, the sunset time is associated with the location of wireless device 324. As such, external server 310 may provide the sunset time data that includes a sunset time value to wireless device 324 via Internet 308 and cellular network 306. Cellular radio 526 may receive the sunset time data and provide the sunset time data to controller 520. Controller 520 may then analyze the sunset time data to obtain the sunset time value, which is associated with the geodetic location of wireless device 324. Controller 520 may then store the sunset time value in memory 522.

In those embodiments wherein the VNS determines the sunset time, the VNS may include a data structure, such as a lookup table that associates the location of the device with a respective sunset time. In these embodiments, the determination of the sunset time is performed by the VNS. For example, as shown in FIG. 4, after GPS network 304 provides geodetic location data (S208) to VNS 303, VNS 303 may determine its geodetic location. In particular, navigation program 423 may include a data structure that associates the location of VNS with a respective sunset time. Controller 420 may execute instructions in navigation program 423 to determine the sunset time based on the data structure within navigation program 423, wherein the sunset time is associated with the location of VNS 303. As such, controller 420 may then analyze the sunset time data to determine a sunset time value, which is associated with the geodetic location of VNS 303. Controller 420 may then store the sunset time value in memory 422.

Similarly, in those embodiments wherein the wireless device determines the sunset time, the wireless device may include a data structure, such as a lookup table that associates the location of the device with a respective sunset time. In these embodiments, the determination of the sunset time is performed by the wireless device. For example, as shown in FIG. 5, after GPS network 304 provides geodetic location data (S208) to wireless device 324, wireless device may determine its geodetic location. In particular, navigation program 523 may include a data structure that associates the location of wireless device 324 with a respective sunset time. Controller 520 may execute instructions in navigation program 523 to determine the sunset time based on the data structure within navigation program 523, wherein the sunset time is associated with the location of wireless device 324. As such, controller 520 may then analyze the sunset time data to determine a sunset time value, which is associated with the geodetic location of wireless device 324. Controller 520 may then store the sunset time value in memory 522.

Further, in cases where the VNS and the wireless device perform processes of algorithm 200 together, there are embodiments where the VNS receives the GPS location data, and the wireless device determines the sunset time. In these embodiments, the determination of the sunset time is performed by the wireless device. For example, as shown in FIG. 6, after GPS network 304 provides geodetic location data (S208) to VNS 333, VNS 333 provides the geodetic location data to wireless device 334. In particular, controller 620 executes instructions in navigation program 623 to instruct radio 626 to transmit the geodetic location data, as received from GPS network 304, to radio 625 of wireless device 334. Wireless device 324 may then determine its geodetic location. In particular, navigation program 631 may include a data structure that associates the location of wireless device 334 with a respective sunset time. Controller 621 may execute instructions in navigation program 631 to determine the sunset time based on the data structure within navigation program 631, wherein the sunset time is associated with the location of wireless device 334. As such, controller 621 may then analyze the sunset time data to determine a sunset time value, which is associated with the geodetic location of wireless device 334. Controller 621 may then store the sunset time value in memory 637.

Further, in cases where the VNS and the wireless device perform processes of algorithm 200 together, there are embodiments where the wireless device receives the GPS location data and the VNS determines the sunset time. In these embodiments, the determination of the sunset time is performed by the VNS. For example, as shown in FIG. 7, after GPS network 304 provides geodetic location data (S208) to wireless device 346, wireless device 346 provides the geodetic location data to VNS 343. In particular, controller 721 executes instructions in navigation program 731 to instruct radio 725 to transmit the geodetic location data, as received from GPS network 304, to radio 726 of VNS 343. VNS 343 may then determine its geodetic location. In particular, navigation program 723 may include a data structure that associates the location of VNS 343 with a respective sunset time. Controller 720 may execute instructions in navigation program 723 to determine the sunset time based on the data structure within navigation program 723, wherein the sunset time is associated with the location of VNS 343. As such, controller 720 may analyze the sunset time data to determine a sunset time value, which is associated with the geodetic location of VNS 343. Controller 720 may then store the sunset time value in memory 722.

Returning to FIG. 2, after a sunset time is determined (S212), it is determined whether a point(s) of interest is(are) chosen (S214). In some embodiments, the VNS may enable a user to choose points of interest (POIs). In some embodiments, the wireless device may enable a user to choose POIs.

Embodiments wherein VNS 303 enable a user to choose POIs will be described with FIG. 4. It should be noted that a VNS may operate in a similar manner with respect to enabling a user to choose POIs in those embodiments discussed above with reference to FIGS. 6 and 7. However, for brevity purposes, only the embodiments discussed with reference to FIG. 4 will be described in greater detail. In particular, controller 420 may execute instructions in navigation program 423 to instruct interface 428 and display 421 to enable a user to choose POIs. Once chosen, controller 420 may store the location of the chosen POIs in memory 422. This may be performed by any known navigation system method.

Similarly, embodiments wherein wireless device 324 enable a user to choose POIs will be described with FIG. 5. It should be noted that a wireless device may operate in a similar manner with respect to enabling a user to choose POIs in those embodiments discussed above with reference to FIGS. 6 and 7. However, for brevity purposes, only the embodiments discussed with reference to FIG. 5 will be described in greater detail. In particular, controller 520 may execute instructions in navigation program 523 to instruct interface 528 and display 521 to enable a user to choose POIs. Once chosen, controller 520 may store the location of the chosen POIs in memory 522. This may be performed by any known navigation system method.

Returning to FIG. 2, if it is determined that no points of interest are chosen (No at S214), then algorithm 200 waits until a point of interest is chosen (return to S214). However, if it is determined that a point(s) of interest is(are) chosen (Yes at S214), then the driving range-area within the sunset time minus the back-off time value is determined (S216). In some embodiments, the VNS determines the driving range-area within the sunset time minus the back-off time value. In some embodiments, the wireless device determines the driving range-area within the sunset time minus the back-off time value.

Embodiments wherein VNS 303 determines the driving range-area within the sunset time minus the back-off time value will be described with FIG. 4. In particular, controller 420 may execute instructions in navigation program 423 to retrieve the back-off time value from navigation program 423. Further, controller 420 may execute instructions in navigation program 423 to retrieve the sunset time value from memory 422. With the route set, the current time known, the current location known, and the sunset time known, controller 420 may determine a driving range-area until sunset. An example driving range-area within the sunset time value is illustrated in FIG. 1B.

Further, controller 420 may execute instructions in navigation program 423 to subtract the back-off time value from the sunset time value to arrive at a decreased driving time. This decreased driving time will result in a decreased driving range-area in accordance with aspects of the present disclosure. Controller 420 may then store the new driving range-area based on the decreased time in memory 422. An example driving range-area within the sunset time value minus the back-off time value is illustrated in FIG. 1C.

Similarly, embodiments wherein wireless device 324 determines the driving range-area within the sunset time minus the back-off time value will be described with FIG. 5. In particular, controller 520 may execute instructions in navigation program 523 to retrieve the back-off time value from navigation program 523. Further, controller 520 may execute instructions in navigation program 523 to retrieve the sunset time value from memory 522. With the route set, the current time known, the current location known, and the sunset time known, controller 520 may determine a driving range-area until sunset.

Further, controller 520 may execute instructions in navigation program 523 to subtract the back-off time value from the sunset time value to arrive at a decreased driving time. This decreased driving time will result in a decreased driving range-area in accordance with aspects of the present disclosure. Controller 520 may then store the new driving range-area based on the decreased time in memory 522.

Similarly, in embodiments wherein the VNS and the wireless device together perform the processes of algorithm 200, there exist embodiments wherein either device may determine the driving range-area within the sunset time minus the back-off time value. For example, in the embodiments of FIG. 6, VNS 333 collects data from GPS network 304, whereas in the embodiments of FIG. 7, VNS 343 collects data from external server 310. However, in the embodiments of FIG. 6, wireless device 334 collects data from external server 310, whereas in the embodiments of FIG. 7, wireless device 334 collects data from GPS network 304.

In some of the embodiments of FIG. 6, controller 620 of VNS 333 may determine the driving range-area within the sunset time minus the back-off time value. In these embodiments, controller 620 may execute instructions in navigation program 623 to enable VNS 333 to determine the driving range-area within the sunset time minus the back-off time value. Controller 620 may obtain data from memory 622 and, if needed, instruct radio 626 to contact radio 625 of wireless device 334 to obtain any other data to determine the driving range-area within the sunset time minus the back-off time value. Controller 620 may then store the new driving range-area based on the decreased time in memory 622.

In some of the embodiments of FIG. 6, controller 621 of wireless device 334 may determine the driving range-area within the sunset time minus the back-off time value. Here, controller 621 may execute instructions in navigation program 631 to enable wireless device 334 to determine the driving range-area within the sunset time minus the back-off time value. Controller 621 may obtain data from memory 637 and, if needed, instruct radio 625 to contact radio 626 of VNS 333 to obtain any other data to determine the driving range-area within the sunset time minus the back-off time value. Controller 621 may then store the new driving range-area based on the decreased time in memory 637.

In some of the embodiments of FIG. 7, controller 720 of VNS 343 may determine the driving range-area within the sunset time minus the back-off time value. In these embodiments, controller 720 may execute instructions in navigation program 723 to enable VNS 343 to determine the driving range-area within the sunset time minus the back-off time value. Controller 720 may obtain data from memory 722 and, if needed, instruct radio 726 to contact radio 725 of wireless device 346 to obtain any other data to determine the driving range-area within the sunset time minus the back-off time value. Controller 720 may then store the new driving range-area based on the decreased time in memory 722.

In some of the embodiments of FIG. 7, controller 721 of wireless device 346 may determine the driving range-area within the sunset time minus the back-off time value. Here, controller 721 may execute instructions in navigation program 731 to enable wireless device 346 to determine the driving range-area within the sunset time minus the back-off time value. Controller 721 may obtain data from memory 737 and, if needed, instruct radio 725 to contact radio 726 of VNS 343 to obtain any other data to determine the driving range-area within the sunset time minus the back-off time value. Controller 721 may then store the new driving range-area based on the decreased time in memory 737.

Returning to FIG. 2, after the driving range-area within the sunset time minus the back-off time value is determined (S216), it is determined whether a point(s) of interest is(are) within the driving range-area (S218).

For example, for purposes of discussion, suppose that the POIs chosen are indicated in FIG. 1B as POIs 106, 108, 110 and 112. A device in accordance with aspects of the present disclosure will determine which of the chosen POIs, if any, are located within the driving range-area within the sunset time minus the back-off time value. For example, for purposes of discussion, of the chosen POIs 106, 108, 110 and 112 as indicated in FIG. 1B, only POIs 110 and 112 are located within the driving range-area within the sunset time minus the back-off time value. Alternatively, no POIs may be located within the driving range-area within the sunset time minus the back-off time value, for example as illustrated in FIG. 1D.

In some embodiments, the VNS determines whether a point(s) of interest is(are) within the driving range-area. In some embodiments, the wireless device determines whether a point(s) of interest is(are) within the driving range-area.

Embodiments wherein VNS 303 determines whether a point(s) of interest is(are) within the driving range-area will be described with FIG. 4. In particular, controller 420 may execute instructions in navigation program 423 to retrieve the retrieve the location of the POIs, if any, from memory 422. Further, controller 420 may execute instructions in navigation program 423 to retrieve the new driving range-area from memory 422. With location of the POIs, if any, and the new driving range-area, controller 420 may determine whether a point(s) of interest is(are) within the driving range-area.

Similarly, embodiments wherein wireless device 324 determines whether a point(s) of interest is(are) within the driving range-area will be described with FIG. 5. In particular, controller 520 may execute instructions in navigation program 523 to retrieve the retrieve the location of the POIs, if any, from memory 522. Further, controller 520 may execute instructions in navigation program 523 to retrieve the new driving range-area from memory 522. With location of the POIs, if any, and the new driving range-area, controller 520 may determine whether a point(s) of interest is(are) within the driving range-area.

In some of the embodiments of FIG. 6, controller 620 of VNS 333 may determine whether a point(s) of interest is(are) within the driving range-area. In particular, controller 620 may execute instructions in navigation program 623 to retrieve the retrieve the location of the POIs, if any, from memory 622. Further, controller 620 may execute instructions in navigation program 623 to retrieve the new driving range-area from memory 622. With location of the POIs, if any, and the new driving range-area, controller 620 may determine whether a point(s) of interest is(are) within the driving range-area.

In some of the embodiments of FIG. 6, controller 621 of wireless device 334 may determine whether a point(s) of interest is(are) within the driving range-area. In particular, controller 621 may execute instructions in navigation program 631 to retrieve the retrieve the location of the POIs, if any, from memory 637. Further, controller 621 may execute instructions in navigation program 631 to retrieve the new driving range-area from memory 637. With location of the POIs, if any, and the new driving range-area, controller 621 may determine whether a point(s) of interest is(are) within the driving range-area.

In some of the embodiments of FIG. 7, controller 720 of VNS 343 may determine whether a point(s) of interest is(are) within the driving range-area. In particular, controller 720 may execute instructions in navigation program 723 to retrieve the retrieve the location of the POIs, if any, from memory 722. Further, controller 720 may execute instructions in navigation program 723 to retrieve the new driving range-area from memory 722. With location of the POIs, if any, and the new driving range-area, controller 720 may determine whether a point(s) of interest is(are) within the driving range-area.

In some of the embodiments of FIG. 7, controller 721 of wireless device 346 may determine whether a point(s) of interest is(are) within the driving range-area. In particular, controller 721 may execute instructions in navigation program 731 to retrieve the retrieve the location of the POIs, if any, from memory 737. Further, controller 721 may execute instructions in navigation program 731 to retrieve the new driving range-area from memory 737. With location of the POIs, if any, and the new driving range-area, controller 721 may determine whether a point(s) of interest is(are) within the driving range-area.

Returning to FIG. 2, if it's determined that no points of interest are within the driving range-area (No at S218), then the map with the driving range-area is displayed (S220). In some embodiments, the VNS displays the map with the driving range-area for the user. In some embodiments, the wireless device displays the map with the driving range-area for the user.

Embodiments wherein VNS 303 displays the map with the driving range-area for the user will be described with FIG. 4. In particular, controller 420 may execute instructions in navigation program 423 to instruct display 421 to display the map with the driving range-area for the user. Display 421 may then display the map with the driving range-area for the user, wherein the map does not include any icons for POIs, as none are included in the driving range-area. FIG. 1D illustrates an example of such a displayed map.

Similarly, embodiments wherein wireless device 324 determines displays the map with the driving range-area for the user will be described with FIG. 5. In particular, controller 520 may execute instructions in navigation program 523 to instruct display 521 to display the map with the driving range-area for the user. Display 521 may then display the map with the driving range-area for the user, wherein the map does not include any icons for POIs, as none are included in the driving range-area.

In some of the embodiments of FIG. 6, VNS 333 may display the map with the driving range-area for the user. In particular, controller 620 may execute instructions in navigation program 623 to instruct display 633 to display the map with the driving range-area for the user. Display 633 may then display the map with the driving range-area for the user, wherein the map does not include any icons for POIs, as none are included in the driving range-area.

In some of the embodiments of FIG. 6, wireless device 334 may display the map with the driving range-area for the user. In particular, controller 621 may execute instructions in navigation program 631 to instruct display 635 to display the map with the driving range-area for the user. Display 635 may then display the map with the driving range-area for the user, wherein the map does not include any icons for POIs, as none are included in the driving range-area.

In some of the embodiments of FIG. 7, VNS 343 may display the map with the driving range-area for the user. In particular, controller 720 may execute instructions in navigation program 723 to instruct display 733 to display the map with the driving range-area for the user. Display 733 may then display the map with the driving range-area for the user, wherein the map does not include any icons for POIs, as none are included in the driving range-area.

In some of the embodiments of FIG. 7, wireless device 346 may display the map with the driving range-area for the user. In particular, controller 721 may execute instructions in navigation program 731 to instruct display 735 to display the map with the driving range-area for the user. Display 735 may then display the map with the driving range-area for the user, wherein the map does not include any icons for POIs, as none are included in the driving range-area.

Returning to FIG. 2, after the map with the driving range-area is displayed (S220), algorithm 200 stops (S224).

However, if is determined that a point(s) of interest is(are) within the driving range-area (Yes at S218), then the map with points of interest within the driving range-area is displayed (S222). In some embodiments, the VNS displays the map with the driving range-area and POIs for the user. In some embodiments, the wireless device displays the map with the driving range-area and POIs for the user.

Embodiments wherein VNS 303 displays the map with the driving range-area and POIs for the user will be described with FIG. 4. In particular, controller 420 may execute instructions in navigation program 423 to instruct display 421 to display the map with the driving range-area and POIs for the user. Display 421 may then display the map with the driving range-area and POIs for the user, wherein the map includes icons for POIs that are within the driving range-area. FIG. 1C illustrates an example of such a displayed map.

Similarly, embodiments wherein wireless device 324 determines displays the map with the driving range-area and POIs for the user will be described with FIG. 5. In particular, controller 520 may execute instructions in navigation program 523 to instruct display 521 to display the map with the driving range-area and POIs for the user. Display 521 may then display the map with the driving range-area and POIs for the user, wherein the map includes icons for POIs that are within the driving range-area.

In some of the embodiments of FIG. 6, VNS 333 may display the map with the driving range-area and POIs for the user. In particular, controller 620 may execute instructions in navigation program 623 to instruct display 633 to display the map with the driving range-area and POIs for the user. Display 633 may then display the map with the driving range-area and POIs for the user, wherein the map includes icons for POIs that are within the driving range-area.

In some of the embodiments of FIG. 6, wireless device 334 may display the map with the driving range-area and POIs for the user. In particular, controller 621 may execute instructions in navigation program 631 to instruct display 635 to display the map with the driving range-area and POIs for the user. Display 635 may then display the map with the driving range-area and POIs for the user, wherein the map includes icons for POIs that are within the driving range-area.

In some of the embodiments of FIG. 7, VNS 343 may display the map with the driving range-area and POIs for the user. In particular, controller 720 may execute instructions in navigation program 723 to instruct display 733 to display the map with the driving range-area and POIs for the user. Display 733 may then display the map with the driving range-area and POIs for the user, wherein the map includes icons for POIs that are within the driving range-area.

In some of the embodiments of FIG. 7, wireless device 346 may display the map with the driving range-area and POIs for the user. In particular, controller 721 may execute instructions in navigation program 731 to instruct display 735 to display the map with the driving range-area and POIs for the user. Display 735 may then display the map with the driving range-area and POIs for the user, wherein the map includes icons for POIs that are within the driving range-area.

Returning to FIG. 2, then the map with points of interest within the driving range-area is displayed (S222), algorithm 200 stops (S224).

A problem with conventional navigation systems is that some users may want to arrive at a destination, or point of interest, prior to sunset. A system and method in accordance with the present disclosure enable a user to be navigated to a destination or a point of interest before sunset.

In accordance with the present disclosure, a system uses navigation to assist users to find points-of-interest (POIs) before dark using a driving range-area. A driving range-area is modified using a back-off time value to obtain a modified driving range-area, wherein the back-off time value is subtracted from a sunset time. For example, an original driving range-area may be desired based on the time of sunset.

The operations disclosed herein may constitute algorithms that can be effected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A device for use with an external server and a global positioning system (GPS) network configured to provide geodetic location data based on a geodetic location of said device, the external server being configured to provide current time data and sunset time data, the current time data including a current time value and the sunset time data including a sunset time value based on the geodetic location, said device comprising:
a display device configured to display a map and a modified map;
a memory; and
a processor configured to execute instructions stored on said memory to cause said device to:
receive the geodetic location data and obtain the geodetic location;
receive the current time data and obtain the current time;
receive the sunset time data and obtain the sunset time;
determine a driving range-area based on the sunset time, the current time, and the geodetic location; and
instruct the display device to display the modified map,
wherein the modified map includes a modified driving-range area based on the geodetic location, the current time and the sunset time.

2. The device of claim 1,
wherein the modified map further includes a driving-range area based on the geodetic location and the current time, and
wherein the driving-range area is smaller than the modified driving-range area.

3. The device of claim 1, wherein said processor is additionally configured to execute instructions stored on said memory to cause said device to:
establish a back-off time value,
wherein the modified map includes a modified driving-range area based on the geodetic location, the current time, the sunset time and the back-off time value.

4. The device of claim 3, for further use by a user, said device further comprising a user interface circuit configured to enable the user to change the back-off time value.

5. The device of claim 4, wherein said processor is additionally configured to execute instructions stored on said memory to cause said device to:
instruct the user interface circuit to enable the user to change the back-off time value in one-hour increments.

6. The device of claim 4, wherein said user interface circuit is additionally configured to enable the user to search for points-of-interest within the modified map.

7. The device of claim 3, wherein the back-off time value is based on a visibility parameter selected from the group of visibility parameters consisting of weather, topography, elevation, and combinations thereof.

8. A method of using a device with an external server and a global positioning system (GPS) network configured to provide geodetic location data based on a geodetic location of the device, the external server being configured to provide current time data and sunset time data, the current time data including a current time value and the sunset time data including a sunset time value based on the geodetic location, the method comprising:
receiving, via a processor configured to execute instructions stored on a memory, the geodetic location data and obtaining the geodetic location;
receiving, via the processor, the current time data and obtaining the current time;
receiving, via the processor, the sunset time data and obtaining the sunset time;
determining, via the processor, a driving range-area based on the sunset time, the current time, and the geodetic location; and
instructing, via the processor, a display device to display the modified map,
wherein the modified map includes a modified driving-range area based on the geodetic location, the current time and the sunset time.

9. The method of claim 8,
wherein the modified map further includes a driving-range area based on the geodetic location and the current time, and
wherein the driving-range area is smaller than the modified driving-range area.

10. The method of claim 8, further comprising:
establishing, via the processor, a back-off time value,
wherein the modified map includes a modified driving-range area based on the geodetic location, the current time, the sunset time and the back-off time value.

11. The method of claim 10, for further use by a user, the method further comprising enabling, via a user interface circuit, the user to change the back-off time value.

12. The method of claim 11, further comprising instructing, via the processor, the user interface circuit to enable the user to change the back-off time value in one-hour increments.

13. The method of claim 11, further comprising enabling, via the user interface circuit, the user to search for points-of-interest within the modified map.

14. The method of claim 10, wherein the back-off time value is based on a visibility parameter selected from the group of visibility parameters consisting of weather, topography, elevation, and combinations thereof.

15. A non-transitory, computer-readable media having computer-readable instructions stored thereon, the computer-readable instructions being capable of being read by a device with an external server and a global positioning system (GPS) network configured to provide geodetic location data based on a geodetic location of the device, the external server being configured to provide current time data and sunset time data, the current time data including a current time value and the sunset time data including a sunset time value based on the geodetic location, wherein the computer-readable instructions are capable of instructing the network controller device to perform the method comprising:
receiving, via a processor configured to execute instructions stored on a memory, the geodetic location data and obtaining the geodetic location;
receiving, via the processor, the current time data and obtaining the current time;
receiving, via the processor, the sunset time data and obtaining the sunset time;
determining, via the processor, a driving range-area based on the sunset time, the current time, and the geodetic location; and
instructing, via the processor, a display device to display the modified map,
wherein the modified map includes a modified driving-range area based on the geodetic location, the current time and the sunset time.

16. The non-transitory, computer-readable media of claim 15, wherein the computer-readable instructions are capable of instructing the network controller device to perform the method
wherein the modified map further includes a driving-range area based on the geodetic location and the current time, and
wherein the driving-range area is smaller than the modified driving-range area.

17. The non-transitory, computer-readable media of claim 15, wherein the computer-readable instructions are capable of instructing the network controller device to perform the method further comprising:
establishing, via the processor, a back-off time value,
wherein the modified map includes a modified driving-range area based on the geodetic location, the current time, the sunset time and the back-off time value.

18. The non-transitory, computer-readable media of claim 17, for further use by a user, wherein the computer-readable instructions are capable of instructing the network controller device to perform the method further comprising enabling, via a user interface circuit, the user to change the back-off time value.

19. The non-transitory, computer-readable media of claim 18, wherein the computer-readable instructions are capable of instructing the network controller device to perform the method further comprising instructing, via the processor, the user interface circuit to enable the user to change the back-off time value in one-hour increments.

20. The non-transitory, computer-readable media of claim 18, wherein the computer-readable instructions are capable of instructing the network controller device to perform the method further comprising enabling, via the user interface circuit, the user to search for points-of-interest within the modified map.
